(19) United States
(12) Patent Application Publication
(10) Pub. No.: US 2014/0329567 A1
(43) Pub. Date: Nov. 6, 2014

(54) MOBILE DEVICE WITH AUTOMATIC VOLUME CONTROL

(71) Applicant: Elwha LLC, Bellevue, WA (US)

(72) Inventors: Alistair K. Chan, Bainbridge Island, WA (US); Roderick A. Hyde, Redmond, WA (US); Muriel Y. Ishikawa, Livermore, CA (US); Jordin T. Kare, Seattle, WA (US); Victoria Y.H. Wood, Livermore, CA (US)

(21) Appl. No.: 13/874,951

(22) Filed: May 1, 2013

(51) Int. Cl. H04M 1/60

(52) U.S. Cl. CPC H04M 1/605
USPC 455/569.2; 455/569.1

(57) ABSTRACT

A mobile device includes a speaker configured to produce output, a proximity sensor configured to generate distance data, an orientation sensor configured to generate orientation data, and a processing circuit. The processing circuit calculates a distance between the mobile device and a region proximate to a user's ear based on the distance data, calculates an angular orientation of the mobile device with respect to the region based on the orientation data, and adjusts the speaker output based on the calculated distance and angular orientation.

### BACKGROUND

Mobile devices, such as smart phones, have become ubiquitous. Under typical circumstances, a speaker of the mobile device is enabled and projects sound during communications (e.g., via an ear speaker, via a speaker for speakerphone mode, etc.), and the user of the mobile device manually adjusts the volume and orientation of the speaker.

### SUMMARY

One exemplary embodiment relates to a mobile device including a speaker configured to produce output, a proximity sensor configured to generate distance data, an orientation sensor configured to generate orientation data, and a processing circuit. The processing circuit is configured to calculate a distance between the mobile device and a region proximate to a user's ear based on the distance data, calculate an angular orientation of the mobile device with respect to the region based on the orientation data, and adjust the speaker output based on the calculated distance and angular orientation.

Another exemplary embodiment relates to a method of optimizing speaker output of a mobile device. The method includes generating distance data based on a signal from a proximity sensor of the mobile device, generating orientation data based on a signal from an orientation sensor of the mobile device, calculating a distance between the mobile device and a region proximate to a user's ear based on the distance data, calculating an angular orientation of the mobile device with respect to the region based on the orientation data, and adjusting the speaker output based on the calculated distance and angular orientation.

Another exemplary embodiment relates to a non-transitory computer-readable medium having instructions stored thereon for execution by a processing circuit. The instructions include instructions for receiving distance data from a proximity sensor of a mobile device, instructions for receiving orientation data from an orientation sensor of the mobile device, instructions for calculating a distance between the mobile device and a region proximate to a user's ear based on the distance data, instructions for calculating an angular orientation of the mobile device with respect to the region based on the orientation data, and instructions for adjusting speaker output of the mobile device based on the calculated distance and angular orientation.

Another exemplary embodiment relates to a mobile device including a speaker configured to produce output, a proximity sensor configured to generate distance data, and a processing circuit. The processing circuit is configured to calculate a distance between the mobile device and a user based on the distance data, determine a target location of the mobile device in relation to the user, compare the calculated distance and the target location, and adjust the speaker output based on the comparison between the calculated distance and the target location.

Another exemplary embodiment relates to a method of optimizing speaker output of a mobile device according to a target location. The method includes generating distance data based on a signal from a proximity sensor of the mobile device, calculating a distance between the mobile device and a user based on the distance data, determining a target location of the mobile device in relation to the user, comparing the calculated distance and the target location, and adjusting a speaker output based on the comparison between the calculated distance and the target location.

Another exemplary embodiment relates to a non-transitory computer-readable medium having instructions stored thereon for execution by a processing circuit. The instructions include instructions for generating distance data based on a signal from a proximity sensor of the mobile device, instructions for calculating a distance between the mobile device and a user based on the distance data, instructions for determining a target location of the mobile device in relation to the user, instructions for comparing the calculated distance and the target location, and instructions for adjusting a speaker output based on the comparison between the calculated distance and the target location.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a block diagram of a mobile device according to an exemplary embodiment.

FIG. 2 is a detailed block diagram of a processing circuit according to an exemplary embodiment.

FIG. 3 is a schematic diagram of a mobile device according to an exemplary embodiment.

FIG. 4 is a schematic diagram of a mobile device according to an exemplary embodiment.

FIG. 5 is a flowchart of a process for automatically adjusting the volume level of a mobile device according to an exemplary embodiment.

FIG. 6 is a flowchart of a process for automatically adjusting the volume level of a mobile device according to an exemplary embodiment.

FIG. 7 is a flowchart of a process for automatically adjusting the volume level of a mobile device according to an exemplary embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring generally to the figures, various embodiments for a mobile device with automatic volume control are shown and described. The mobile device may be a mobile phone, a cordless phone, a media player with communication capabilities, a tablet computing device, etc. In use, a user may enable a speakerphone mode on the mobile device and pull the mobile device away from his or her ear. In another example, the user may pull the phone away from his or her ear to see the screen of the mobile device during a communication (e.g., phone call, video chat, etc.). Utilizing a proximity sensor (e.g., a radar sensor, micropower impulse radar (MIR), light detection and ranging technology, a microphone, an ultrasonic sensor, an infrared sensor, a near-infrared (NIR) sensor, or any other sensor that is capable of measuring range, etc.), the mobile device automatically detects the distance of the speaker (or speakers) to the user's ear (left or right). Utilizing the distance information and an orientation sensor (e.g., a gyroscope, an accelerometer, a magnetic sensor, or any other similar orientation sensing device), the mobile device detects the mobile device's orientation with respect to the user's ear. The mobile device processes the information and automatically adjusts the speaker output (volume, frequency profile, etc.) in response to the mobile device's position with respect to the user's ear.

In one embodiment, the mobile device increases the volume of the speaker as the device is moved further from the user's ear and decreases the volume as the device is moved closer to the user's ear. The mobile device may limit the adjustment to a minimum or maximum volume. In one embodiment, the adjustment of the volume of the speaker is based purely on a distance calculation (i.e. the distance between the device and the user's ear).

In another embodiment, the mobile device adjusts the volume of the speaker such that it is optimized and set to an ideal level for a particular location with respect to the user's ear. In this manner, the mobile phone may determine a “sweet spot” or a target location, where the volume and speaker output is ideal for the user, or is set to a level that the user prefers. At locations other than the target/ideal location, the volume and speaker output may be such that it is unsatisfactory for the user. As an example, the target location may include spatial, orientation, and distance information. As another example, the target location may include a target distance of the mobile device from the user. Such a target distance may be a preset fixed distance from the user or a variable distance based on a user setting. Alternatively, the target location may be based on a distance with respect to a region proximate to the user's ear or head. By adjusting the speaker output of the mobile device based on the target location or distance, a user can be encouraged to hold their mobile device in a certain position, or discouraged from holding their mobile device in a certain position (e.g., at a close distance for a speaker volume that can be damaging to the user's ear, etc.).

In another embodiment, the mobile device adjusts the direction of the speaker's output (e.g., electronically or mechanically) such that the output is better aimed at the user's ear. The mobile device determines the distance and orientation of the speaker with respect to the user's ear. The mobile device may cause the speaker to mechanically change positioning such that the speaker's output is directionally pointed at the user's ear. The mobile device may also adjust the speaker's output via electronic means. For example, the speaker may comprise an array of transducers which can be differentially excited to control the directional emission from the array. As another example, the speaker may contain ultrasonic components capable of directionally outputting ultrasonic audio which nonlinearly downconverts to audible frequencies at or near the user's ear. The mobile device adjusts the directional output of the ultrasonic components accordingly.

In another embodiment, the mobile device adjusts additional settings of the mobile device (e.g., changing screen brightness, changing an operating mode of the device, displaying an alert, etc.). These adjustment may be made separately or in conjunction with adjustments made to the speaker.

The above described distance and orientation sensing systems may be enabled or disabled by a user as the user desires. Additionally, a user may specify preferences in order to set characteristics of the adjustments. The user may also specify a desired location and distance from the user's ear, where the user prefers to hold the device. The user may also specify a maximum, minimum, and desired volume of the speaker. The above systems may further be enabled or disabled according to a schedule, which may be adjusted by the user via the graphical user interface of the mobile device. These settings may be stored in a preference file. Default operating values may also be provided.

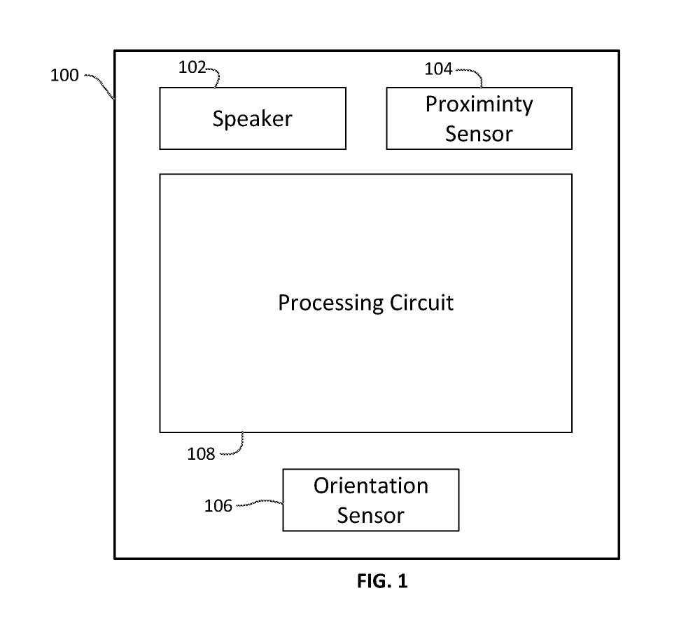

Referring to FIG. 1, a block diagram of mobile device 100 for executing the systems and methods of the present disclosure is shown. According to an exemplary embodiment, mobile device 100 includes at least one speaker 102 for providing audio to a user, proximity sensor 104 for measuring distances from mobile device to a user, orientation sensor 106 for sensing the orientation of the mobile device, and processing circuit 108. Speaker 102 includes components necessary to produce audio. Speaker 102 may be a single speaker, or may include a plurality of speaker components. Speaker 102 may be capable of producing mono, stereo, and three-dimensional audio effects beyond a left channel and right channel. Proximity sensor 104 includes components necessary to generate distance information and/or three-dimensional information (e.g., a sonic or ultrasonic device, a microphone, an infrared device, a micropower impulse radar device, a light detection and ranging device, multiple cameras for stereoscopic imaging, a camera which determines range by focal quality, a camera in cooperation with a range sensor, or any other component capable of measuring distance or three-dimensional location, etc.). Orientation sensor 106 includes components necessary to detect the spatial orientation of mobile device 100. Orientation sensor 106 may include a gyroscopic device, a single-axis or multi-axis accelerometer, multiple accelerometers, or any combination of devices capable of maintaining angular references and generating orientation data. Data collected by proximity sensor 104 and orientation sensor 106 is provided to processing circuit 108. Processing circuit 108 analyzes the distance and orientation data to determine the geometry of the mobile device with respect to the user (e.g., distance of the mobile device and/or the speaker to the user's ear, 3-D location of the mobile device and/or the speaker with respect to the user's ear, orientation of the mobile device and/or speaker with reference to the user's ear, orientation of the mobile device and/or speaker with reference to the direction between the mobile device and/or the speaker and the user's ear, etc.). It should be understood that although proximity sensor 104 and orientation sensor 106 are depicted as separate components in FIG. 1, they may be part of a single component capable of providing distance and orientation data.

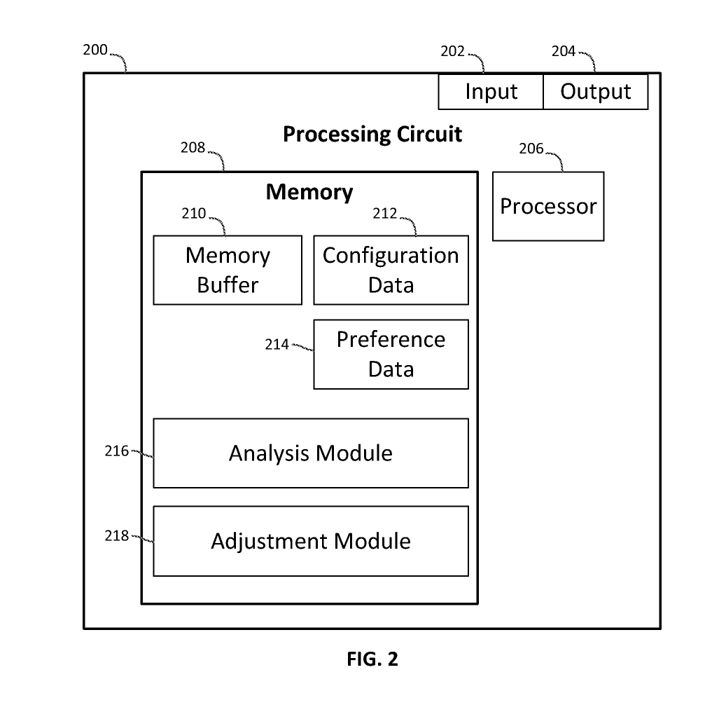

Referring to FIG. 2, a detailed block diagram of processing circuit 200 for completing the systems and methods of the present disclosure is shown according to an exemplary embodiment. Processing circuit 200 may be processing circuit 108 of FIG. 1. Processing circuit 200 is generally configured to accept input from an outside source (e.g., a proximity sensor, an orientation sensor, etc.). Processing circuit 200 is further configured to receive configuration and preference data. Input data may be accepted continuously or periodically. Processing circuit 200 uses the input data to analyze the distance from the speaker of the mobile device to a user's ear, to analyze the orientation of the speaker of mobile device with reference to a user's ear, and to determine if an adjustment should to be made to the speaker (e.g., a volume adjustment, a frequency profile adjustment, a directional adjustment, etc.). Processing circuit 200 may further use the input data to adjust other settings or components of the mobile device (e.g., changing a screen brightness setting, etc.). Processing circuit 200 generates signals necessary to facilitate adjustments as described herein.

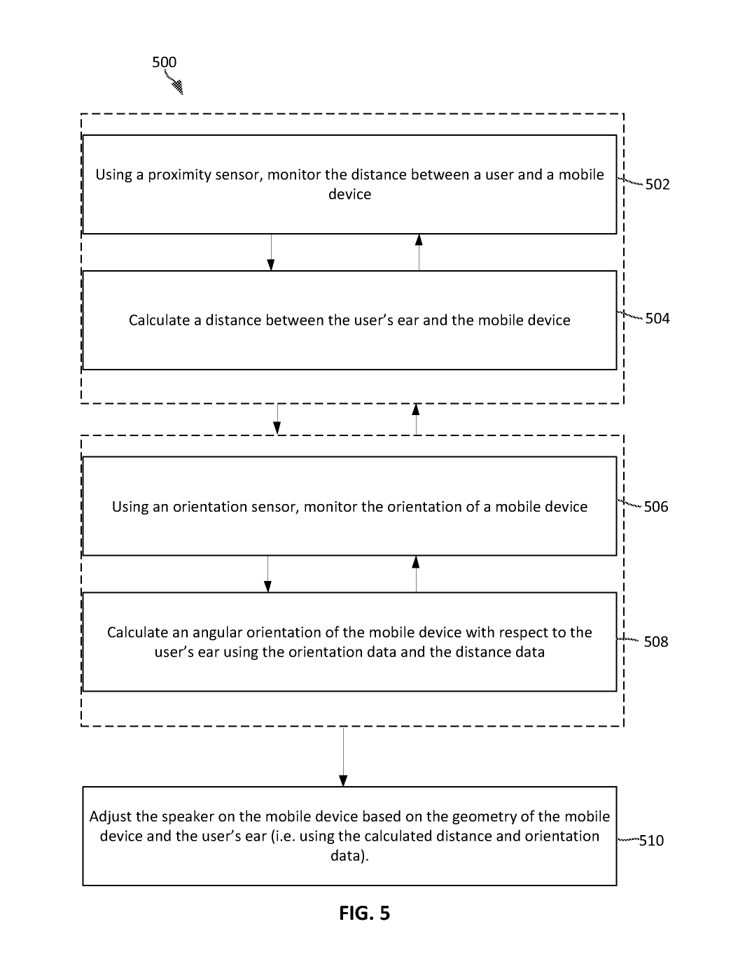

According to an exemplary embodiment, processing circuit 200 includes processor 206. Processor 206 may be implemented as a general-purpose processor, an application specific integrated circuit (ASIC), one or more field programmable gate arrays (FPGAs), a group of processing components, or other suitable electronic processing components. Processing circuit 200 also includes memory 208. Memory 208 is one or more devices (e.g., RAM, ROM, Flash Memory, hard disk storage, etc.) for storing data and/or computer code for facilitating the various processes described herein. Memory 208 may be or include non-transient volatile memory or non-volatile memory. Memory 208 may include database components, object code components, script components, or any other type of information structure for supporting the various activities and information structures described herein. Memory 208 may be communicably connected to the processor 206 and include computer code or instructions for executing the processes described herein (e.g., the processes shown in FIGS. 5-7).

Memory 208 includes memory buffer 210. Memory buffer 210 is configured to receive data from a sensor (e.g. proximity sensor 104, orientation sensor 106, etc.) through input 202. For example, the data may include distance and ranging information, location information, orientation information, sonic or ultrasonic information, radar information, and mobile device setting information. The data received through input 202 may be stored in memory buffer 210 until memory buffer 210 is accessed for data by the various modules of memory 208. For example, analysis module 216 and adjustment module 218 each can access the data that is stored in memory buffer 210.

Memory 208 further includes configuration data 212. Configuration data 212 includes data relating to processing circuit 200. For example, configuration data 212 may include information relating to interfacing with other components of a mobile device. This may include the command set needed to interface with graphic display components, for example, a graphics processing unit (GPU). As another example, configuration data 212 may include information as to how often input should be accepted from a sensor of the mobile device. Configuration data 212 further includes data to configure communication between the various components of processing circuit 200.

Memory 208 further includes modules 216 and 218 for executing the systems and methods described herein. Modules 216 and 218 are configured to receive distance information, orientation information, sensor information, radar information, sonic or ultrasonic information, mobile device setting information, preference data, and other data as provided by processing circuit 200. Modules 216 and 218 are generally configured to analyze the data, determine the geometry of the mobile device with respect to a user (i.e., the distance and orientation of the mobile device device's speaker to the user's ears and head), and determine whether to adjust the directional output and/or volume of the speaker. Modules 216 and 218 may be further configured to maintain a certain volume level and frequency profile as a user changes the position and/or orientation of the mobile device.

Analysis module 216 is configured to receive distance data from a proximity sensor and orientation data from an orientation sensor (e.g., proximity sensor 104 of FIG. 1, orientation sensor 106 of FIG. 1, etc.). The distance data may be a range, or it may include more general 3-D location information. The distance and orientation data may be provided through input 202 or through memory buffer 210. Analysis module 216 scans the distance and orientation data and analyzes the data. Analysis module 216 determines the distance from the mobile device and/or the speaker relative to the user (e.g., the user's ears, etc.). In general, this distance (or 3D location) is with respect to a region proximate to the user's ear. In some embodiments, the region comprises the ear itself, or at least a portion of the ear. In some embodiments, the region comprises a portion of the user's head near the ear, while in some embodiments it comprises a region of air near the ear. In one embodiment, this distance or location measurement is achieved by analyzing the reflections of an ultrasonic signal provided by an ultrasonic proximity sensor. In one example, analysis module 216 may determine the location of a user's ear, and apply an offset to determine the location of the user's brain. In another embodiment, this is achieved by analyzing radar information provided by a radar proximity sensor. A profile of user features (e.g., head and ear dimensions, proportions, spacing, etc.) may be constructed from the sensor data. Sensor data may be compared to standard pre-stored profiles of average or representative users in initially determining features of a particular user. In determining a user feature profile, analysis module 216 may make use of machine learning, artificial intelligence, interactions with databases and database table lookups, pattern recognition and logging, intelligent control, neural networks, fuzzy logic, etc. In this manner, analysis module 216 may store and update user feature profiles in order to tailor them for a particular user.

Analysis module 216 uses the user feature profile, the determined distance and/or location, and the orientation data to determine the geometry of the mobile device with respect to the user. Analysis module 216 may make use of algorithms that utilize a spherical coordinate system, and such algorithms may include the calculation of an angle of inclination and an azimuth angle. The angle of inclination may refer to the angle a user's feature (e.g., ear, head, etc.) with respect to the speaker of the mobile device. The azimuth angle may refer to the degree the user's feature (e.g., ear, head, etc.) is off-center from a speaker of the mobile device. The determined distance may be used as a radial distance in the spherical coordinate system. The inclination and azimuth angles may be expressed with respect to coordinate axes of the mobile device or of the speaker. Analysis module 216 may also apply offsets to the determined distance and calculated angles in order to compensate for the difference in location of the sensors on the mobile device and the speaker. For example, the proximity sensor may be located on the top of the mobile device, and the speaker may be located on the bottom, and analysis module 216 may apply an appropriate offset to compensate for the difference in location. In this manner, an accurate calculation of distance and orientation may be achieved. Offsets may be adjusted to correspond to a particular mobile device configuration. Analysis module 216 provides the determined three-dimensional geometry to adjustment module 218 for further processing.

Numerous speaker adjustment configurations are envisioned to be within the scope of this application, and adjustment module 218 may use any combination of the following configurations. In an exemplary embodiment, adjustment module 218 compares the received geometry data to preset threshold values or user preference values. Adjustment module 218 uses this comparison to determine whether to adjust the volume of the speaker. Adjustment module 218 also uses this comparison to determine whether to adjust a frequency profile of the speaker. Such frequency profiles may comprise the spectral profile (i.e., amplitude versus frequency) of sound emitted by the speaker, and may correspond to a particular user profile. Frequency profiles may include the amount of noise accompanying a primary audio output, may include frequency distortions, may include an excess or dearth of low or high frequency components, or similar effects. Frequency profiles may be edited and adjusted by a user, may be based on user settings, may be based on pre-stored frequency profiles, and may be adjusted based on a target location or target distance of the mobile device. Frequency profiles may contain preferred frequency information or non-preferred frequency information. In one example, adjustments to the speaker may only be made when the distance the speaker is from an object (or user's ear) is within a certain range. For example, if the distance indicates a large distance, adjustment module 218 may determine that the mobile device is not directed at a user. In one embodiment, the mobile device includes both ultrasonic and sonic speakers, and adjustment module 218 uses a threshold in switching between ultrasonic and sonic speakers. In some embodiments, ultrasonic speakers may be used, exploiting their short wavelengths in order to deliver directional audio. The ultrasound can use nonlinear interactions in air or tissue near the user to downconvert the ultrasound to an audible range. Another nonlinear downconversion process involves the blending of two or more ultrasonic frequencies to deliver audible frequencies. For example, when the distance that the speaker is from a user's ear exceeds a defined threshold, adjustment module 218 may enable the ultrasonic speakers to directly beam audio to the user's ear. At a distance less than the threshold, adjustment module 218 disables the ultrasonic speakers and enables the sonic speakers of the mobile device.

In another exemplary embodiment, adjustment module 218 adjusts the speaker based purely on distance to the user's ear. For example, adjustment module 218 may cause the volume of the speaker to increase as the distance between the speaker and the user's ear increases. In the same manner, adjustment module 218 may cause the volume of the speaker to decrease as the distance between the speaker and the user decreases.

In another exemplary embodiment, adjustment module 218 accesses stored speaker information. Speaker information may be stored in configuration data 212, and may include information relating to the spatial emission pattern (e.g., a three-dimensional angular-range pattern, etc.) of the particular speaker(s) of the mobile device. Adjustment module 218 uses the emission data in adjusting output of the speaker(s). Adjustment module 218 compares the emission data to the geometry received from analysis module 216. If the comparison indicates that the user's ear is not within the optimal location for the speaker's output, adjustment module 218 may cause the volume of the speaker to increase. If the comparison indicates that the user's ear is within the optimal location for the speaker's output, adjustment module 218 cause the volume of the speaker to remain constant.

In another exemplary embodiment, adjustment module 218 causes the user perceived volume of the speaker to remain substantially constant (e.g., within a 5%, 10%, 20%, 30%, or 50% fluctuation, etc.) despite changes in the mobile device's location or orientation. Adjustment module 218 may increase the speaker volume, decrease the speaker volume, or otherwise adjust the speakers as described herein in order to maintain the volume level (i.e. received sound intensity) or frequency profile at the user's ear at a fixed level. In this manner, a user may alter the position of the mobile device, but may still receive a constant audio quality communication.

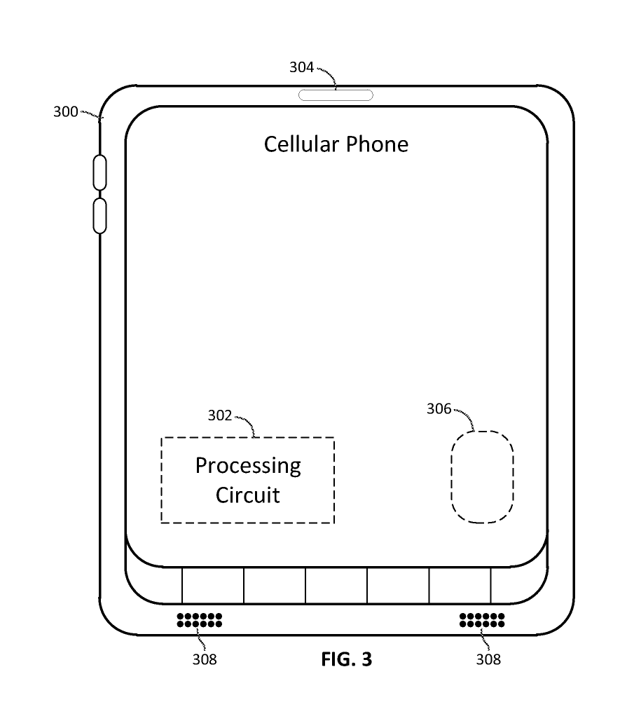

In one embodiment, the mobile device (e.g., mobile device 300 of FIG. 3) has multiple speakers. Adjustment module 218 adjusts the output of the speakers according to the geometry received from analysis module 216 and the orientation of the mobile device. For example, if the front of the mobile device is facing towards the user, adjustment module 218 may cause the front-facing speaker(s) to be enabled. If the user rotates the mobile device such that it is facing the opposite direction, adjustment module 218 may cause the rear-facing speaker(s) to be enabled. Adjustment module 218 may enable, disable, adjust the volume, adjust the frequency profile, or otherwise adjust each speaker individually or in concert with another speaker of the mobile device.

In one embodiment, adjustment module 218 receives data corresponding to ambient noise surrounding the mobile device. Ambient noise data may be provided by any audio sensor (e.g., an ultrasonic transducer, microphone, etc.) coupled to the mobile device. Adjustment module 218 incorporates the ambient noise data in adjusting the output of the speakers as described herein. For example, if the ambient noise data indicates that there is a large amount of background noise, adjustment module 218 may increase the volume of the speaker. Similarly, if the ambient noise data indicates the presence of a small amount of background noise, adjustment module 218 may adjust the volume of the speaker proportionally to the level of background noise.

In another exemplary embodiment, adjustment module 218 adjusts the speaker such that interaction of electromagnetic radiation produced by the mobile device is reduced or minimized with the user's head. In some embodiments the goal is to reduce absorption of emitted electromagnetic radiation in the user's brain. In some embodiments the goal is to reduce reflections of emitted electromagnetic radiation from the user's head. In some embodiments the goal is to reduce the loss of incident electromagnetic signals intended for reception by the mobile device caused by attenuation in the user's head. Adjustment module 218 receives the mobile device and user geometry from analysis module 216. Adjustment module 218 further receives electromagnetic radiation pattern information corresponding to radiation generated by transmitters of the mobile device. Electromagnetic radiation information may be stored in configuration data 212. Based on the received geometry and electromagnetic radiation information, adjustment module 218 determines a target or ideal location of the mobile device with respect to the user's head. In the target location, or at a target distance from the user, flux of electromagnetic radiation through a user's brain may be minimized. For example, the target location may be such that transmitters of the mobile device are not directly aimed at a user's head. In some embodiments, the user sets the target location using his own chosen criteria. As an example, the user may hold the mobile device at a location, and then designate this location as his ideal location by pushing a button, selecting an option, issuing a voice command, etc. In some embodiments, the user sets a preferred speaker output (e.g., preferred volume level, or preferred frequency profile) using his own chosen criteria. As an example, the user may hold the mobile device at a location (which may or may not be at the target location), and then designate the volume level or frequency profile as his preferred values by pushing a button, selecting an option, issuing a voice command, etc. Adjustment module 218 adjusts the output of the speaker in order to encourage a user to hold the mobile device in the target location. As an example, this may include decreasing or increasing the volume of the speaker to an undesirable level relative to the preferred volume level when the mobile device is in a non-ideal/non-target location. As another example, this may include adjusting the directional output of the speaker such that the user holds the mobile device in a position where electromagnetic flux is minimized. As another example, this may include superimposing an alert audio signal over the speaker audio signal when the mobile device is in a location where electromagnetic flux is increased. As another example, this may include superimposing an confirmation audio signal over the speaker audio signal when the mobile device is in a location where electromagnetic flux is minimized. As another example, this may include making adverse changes to the frequency profile (e.g., adding noise, distorting the frequency spectrum, adding/removing high or low frequencies, etc.). As another example, this may include causing a graphical user interface of the mobile device to display an alert when the mobile device is in a location where electromagnetic flux is minimized or increased, respectively. These adjustments may also be applied in the other embodiments discussed herein.

Processing circuit 200 further includes output 204 configured to provide an output to an electronic display, or other components within a mobile device. Exemplary outputs may include commands, preference file information, and other information related to adjusting the mobile device, include adjustments to the volume, frequency profile, orientation, or directional output of a speaker as described above. Outputs may be in a format required to instantiate such an adjustment on the mobile device, and may be defined by requirements of a particular mobile operating system. In one example, the output includes parameters required to set a volume level. In another example, the output includes a command to cause the mobile device to change the physical orientation and directional output of a speaker.

Referring to FIG. 3, a schematic diagram of mobile device 300, processing circuit 302, proximity sensor 304, orientation sensor 306, and speakers 308 are shown according to an exemplary embodiment. Mobile device 300 is depicted as a mobile phone. Processing circuit 302 includes the internal processing components of the mobile phone. Processing circuit 302 contains modules and components as described above (e.g., modules as discussed for processing circuit 200 of FIG. 2). Proximity sensor 304 is coupled to the mobile phone. In an exemplary embodiment, orientation sensor 306 includes an internal gyroscope device. Speakers 308 may be a single speaker, or may include multiple speakers. Speakers 308 may include both ultrasonic speaker components and electroacoustic transducer components. Speakers 308 may be fixed position speakers, or may be directionally adjustable via mechanical means. The scope of the present application is not limited to a particular arrangement of sensors or detectors.

In an exemplary embodiment, mobile device 300 is a tablet computing device that is capable of voice-over-internet protocol (VoIP) communication. Proximity sensor 304 is an ultrasonic distance sensor coupled to the tablet computer. Proximity sensor 304 may be a component of a camera module of the tablet computing device. Processing circuit 302 is the processing circuit of the tablet computer that is configured to implement the systems and methods described herein. Orientation sensor 306 is as an internal three-dimensional gyroscope that is capable of providing orientation information (e.g. angular rates of rotations, etc.) to processing circuit 302.

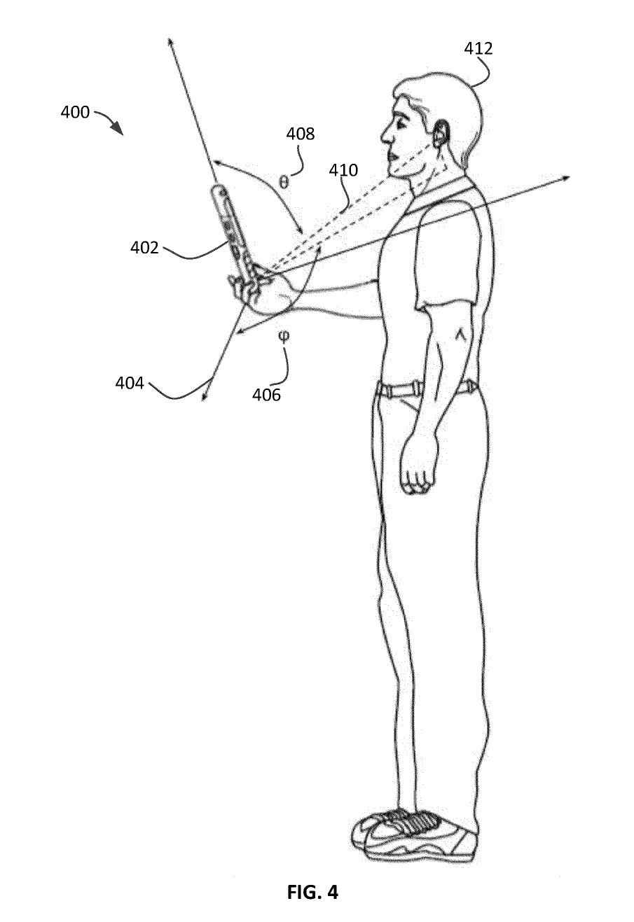

Referring to FIG. 4, a schematic diagram of mobile device 402, user 412, and geometry 400 is shown according to an exemplary embodiment. Mobile-device-and-user geometry 400 includes mobile device 402, three-dimensional axis 404, and user 412. Mobile device 402 may be a mobile device as described herein (e.g., mobile device 100 of FIG. 1, mobile device 300 of FIG. 3, etc.). Mobile device is shown as calculating an angle of inclination 408 and azimuth angle 406. Angle of inclination 408 and azimuth angle 406 may be calculated by processing data (e.g., by analysis module 216 in processing circuit 200 of FIG. 2) provided by an orientation sensor as described herein. The speaker of mobile device 402 is depicted as being radial distance 410 away from the ear of user 412. Radial distance 410 may be calculated by processing data (e.g., by analysis module 216 in processing circuit 200 of FIG. 2) provided by a proximity sensor as described herein. Geometry 400 and positioning of mobile device 402 with respect to user 412 is determined and used in making adjustments to a speaker of mobile device 408 or in making other adjustments to mobile device 408 (e.g., as described for adjustment module 218 of FIG. 2, etc.).

Referring to FIG. 5, a flow diagram of a process 500 for determining the geometry of a mobile phone with respect to a user and adjusting the volume of the speaker of the mobile device based on the geometry, is shown, according to an exemplary embodiment. In alternative embodiments, fewer, additional, and/or different steps may be performed. Also, the use of a flow diagram is not meant to be limiting with respect to the order of steps performed. Process 500 includes using a proximity sensor to monitor the distance between a user and a mobile device (step 502) and calculating a distance between the user's ear and the mobile device (step 504). Process 500 further includes using an orientation sensor to monitor the orientation of a mobile device (step 506) and calculating an angular orientation of the mobile device with respect to the user's ear using the orientation data and the distance data (step 508). Using the calculated distance and orientation data, the speaker of the mobile device is adjusted (e.g., volume increased, volume decreased, frequency profile changed, directionally changed, etc.) (step 510).

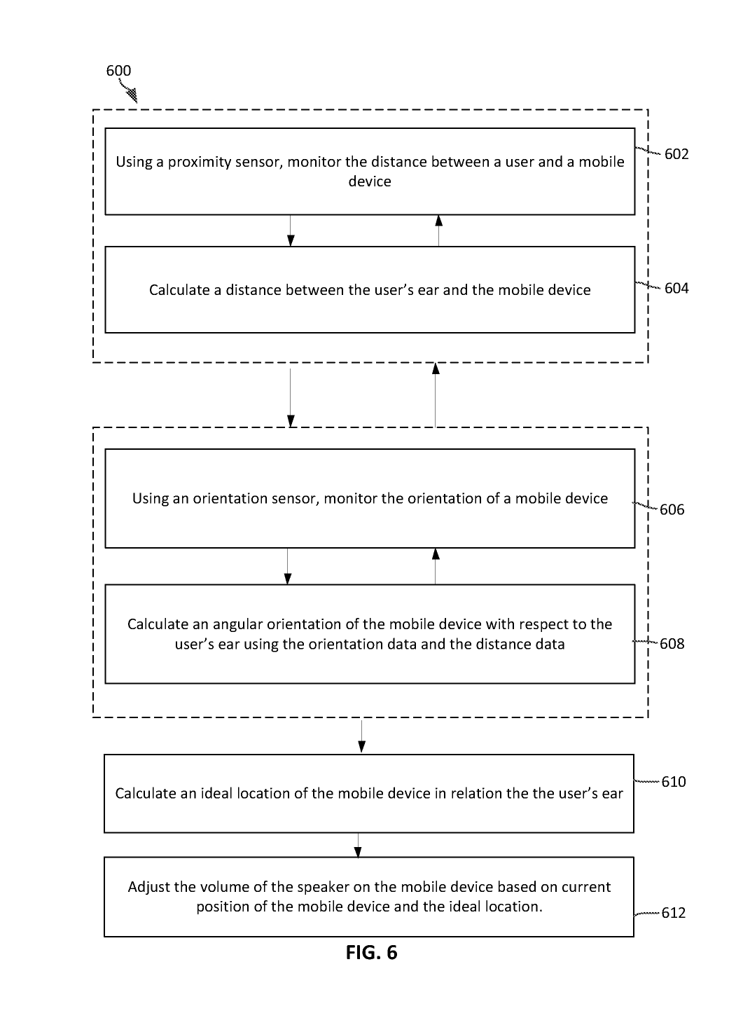

Referring to FIG. 6, a flow diagram of a process 600 for determining the geometry of a mobile phone with respect to a user and adjusting the volume of the speaker of the mobile device based on the geometry, is shown, according to an exemplary embodiment. In alternative embodiments, fewer, additional, and/or different steps may be performed. Also, the use of a flow diagram is not meant to be limiting with respect to the order of steps performed. Process 600 includes using a proximity sensor to monitor the distance between a user and a mobile device (step 602) and calculating a distance between the user's ear and the mobile device (step 604). Process 600 further includes using an orientation sensor to monitor the orientation of a mobile device (step 606) and calculating an angular orientation of the mobile device with respect to the user's ear using the orientation data and the distance data (step 608). An ideal location of the mobile device in relation to the user's ear is calculated (step 610). This calculation may be based on user settings, predefined settings, the particular spatial pattern of the speaker emissions, or a configuration selected in order to minimize electromagnetic absorption in the user's brain. Using the calculated distance and orientation data (e.g., the geometry of the mobile device with respect to the user) and the calculated ideal location, the speaker of the mobile device is adjusted (e.g., volume increased, volume decreased, directionally changed, etc.) (step 612).

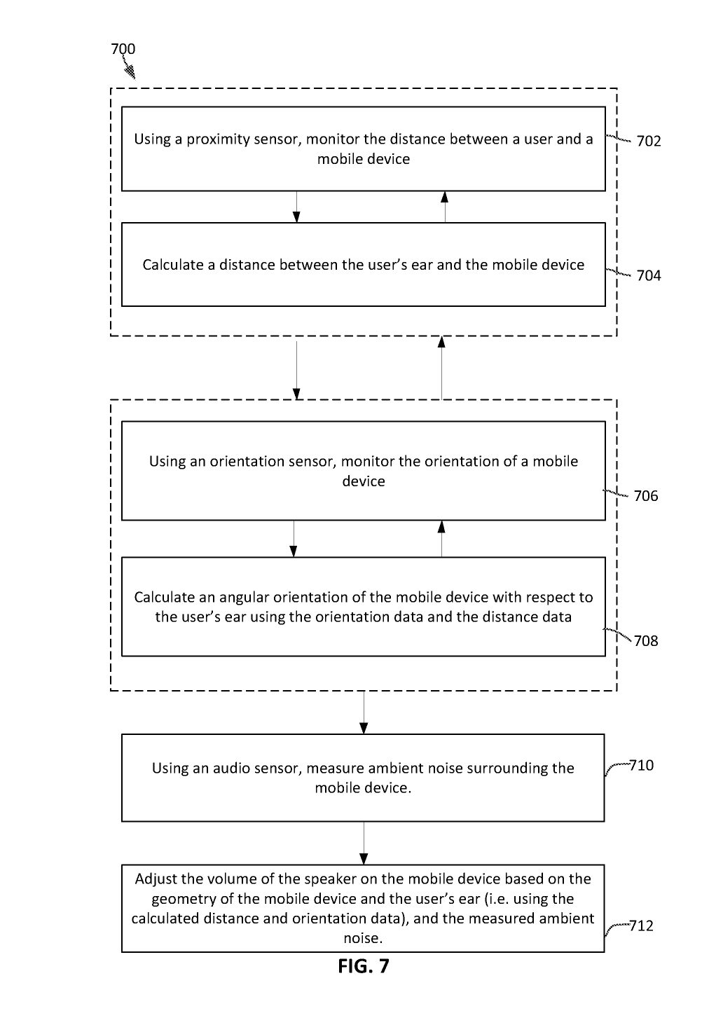

Referring to FIG. 7, a flow diagram of a process 700 for determining the geometry of a mobile phone with respect to a user and adjusting the volume of the speaker of the mobile device based on the geometry, is shown, according to an exemplary embodiment. In alternative embodiments, fewer, additional, and/or different steps may be performed. Also, the use of a flow diagram is not meant to be limiting with respect to the order of steps performed. Process 700 includes using a proximity sensor to monitor the distance between a user and a mobile device (step 702) and calculating a distance between the user's ear and the mobile device (step 704). Process 700 further includes using an orientation sensor to monitor the orientation of a mobile device (step 706) and calculating an angular orientation of the mobile device with respect to the user's ear using the orientation data and the distance data (step 708). Using an audio sensor, ambient noise surrounding the mobile device is measured (step 710). Using the calculated distance and orientation data and the measured ambient sound, the volume of the speaker of the mobile device is adjusted (e.g., increased, decreased, maintained, etc.) (step 712).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A mobile device, comprising:
a speaker configured to produce output;
a proximity sensor configured to generate distance data;
an orientation sensor configured to generate orientation data; and
a processing circuit configured to:
calculate a distance between the mobile device and a region proximate to a user's ear based on the distance data;
calculate an angular orientation of the mobile device with respect to the region based on the orientation data; and
adjust the speaker output based on the calculated distance and angular orientation.

2-8. (canceled)

9. The mobile device of claim 1, wherein the speaker output is adjusted according to a change in the distance between the mobile device and the region or a change in the angular orientation of the mobile device with respect to the region.

10. (canceled)

11. The mobile device of claim 1, wherein the speaker output is adjusted in order to maintain a substantially constant volume at the user's ear.

12. The mobile device of claim 1, wherein the speaker output is adjusted in order to maintain a substantially constant audio frequency profile at the user's ear.

13. The mobile device of claim 1, wherein adjusting the speaker output includes adjusting a directional output of the speaker.

14-15. (canceled)

16. The mobile device of claim 13, wherein the directional output of the speaker is adjusted by varying an excitation of at least one of a plurality of transducers.

17. (canceled)

18. The mobile device of claim 1, wherein the speaker comprises components configured to provide both ultrasound output and audible sound output.

19. The mobile device of claim 18, wherein adjusting the speaker output includes switching between ultrasound output and audible sound output.

20-24. (canceled)

25. The mobile device of claim 1, further comprising a sensor configured to measure an ambient noise level, and wherein adjusting the speaker output is further based on the ambient noise level.

26-29. (canceled)

30. The mobile device of claim 1, wherein the processing circuit is further configured to determine a target location of the mobile device in relation to the region, and wherein adjusting the speaker output is further based on the target location.

31-32. (canceled)

33. The mobile device of claim 30, wherein the target location is determined in order to reduce interaction of electromagnetic radiation emitted by the mobile device with a user's head.

34. (canceled)

35. The mobile device of claim 30, wherein adjusting the speaker output comprises adjusting a volume level of the speaker to a preferred volume level at the target location.

36-41. (canceled)

42. The mobile device of claim 30, wherein adjusting the speaker output comprises adjusting a frequency profile of the speaker to a preferred frequency profile at the target location.

43-45. (canceled)

46. The mobile device of claim 30, wherein adjusting the speaker output comprises adjusting a frequency profile of the speaker to a non-preferred frequency profile at a location other than the target location.

47. The mobile device of claim 46, wherein the non-preferred frequency profile has at least one of more noise than a preferred frequency profile, more low frequency content than a preferred frequency profile, more high frequency content than a preferred frequency profile, and more frequency distortion than a preferred frequency profile.

48-59. (canceled)

60. A method of optimizing speaker output of a mobile device, comprising:
generating distance data based on a signal from a proximity sensor of the mobile device;
generating orientation data based on a signal from an orientation sensor of the mobile device;
calculating a distance between the mobile device and a region proximate to a user's ear based on the distance data;
calculating an angular orientation of the mobile device with respect to the region based on the orientation data; and
adjusting the speaker output based on the calculated distance and angular orientation.

61-67. (canceled)

68. The method of claim 60, wherein the speaker output is adjusted according to a change in the distance between the mobile device and the region or a change in the angular orientation of the mobile device with respect to the region.

69. (canceled)

70. The method of claim 60, wherein the speaker output is adjusted in order to maintain a substantially constant volume at the user's ear.

71. The method of claim 60, wherein the speaker output is adjusted in order to maintain a substantially constant audio frequency profile at the user's ear.

72-76. (canceled)

77. The method of claim 60, wherein the speaker comprises components configured to provide both ultrasound output and audible sound output, and wherein adjusting the speaker output includes switching between ultrasound output and audible sound output.

78-81. (canceled)

82. The method of claim 60, further comprising adjusting output of at least one additional speaker of the mobile device based on the calculated distance and angular orientation.

83-88. (canceled)

89. The method of claim 60, further comprising determining a target location of the mobile device in relation to the region, and wherein adjusting the speaker output is further based on the target location.

90-93. (canceled)

94. The method of claim 89, wherein adjusting the speaker output comprises adjusting a volume level of the speaker to a preferred volume level at the target location.

95-100. (canceled)

101. The method of claim 89, wherein adjusting the speaker output comprises adjusting a frequency profile of the speaker to a preferred frequency profile at the target location.

102-177. (canceled)

178. A mobile device, comprising:
a speaker configured to produce output;
a proximity sensor configured to generate distance data; and
a processing circuit configured to:
calculate a distance between the mobile device and a user based on the distance data;
determine a target location of the mobile device in relation to the user;
compare the calculated distance and the target location; and
adjust the speaker output based on the comparison between the calculated distance and the target location.

179. The mobile device of claim 178, wherein the calculated distance includes three-dimensions of distance information.

180-182. (canceled)

183. The mobile device of claim 178, wherein the speaker output is adjusted in order to maintain a substantially constant volume at the user's ear.

184. The mobile device of claim 178, wherein the speaker output is adjusted in order to maintain a substantially constant audio frequency profile at the user's ear.

185. The mobile device of claim 178, wherein adjusting the speaker output includes adjusting a directional output of the speaker.

186-198. (canceled)

199. The mobile device of claim 178, wherein the target location is based on at least one of a fixed distance from the user, a variable distance from the user, a distance from a region proximate to the user's ear, and a user setting.

200-204. (canceled)

205. The mobile device of claim 178, wherein the target location is determined in order to reduce attenuation by a user's head of electromagnetic radiation directed to the mobile device.

206. The mobile device of claim 178, wherein adjusting the speaker output comprises adjusting a volume level of the speaker to a preferred volume level at the target location.

207. The mobile device of claim 206, wherein the preferred volume level is based on at least one of a user setting and hearing characteristics of a representative user.

208-209. (canceled)

210. The mobile device of claim 178, wherein adjusting the speaker output comprises adjusting a volume level of the speaker to a non-preferred volume level at a location other than the target location.

211-212. (canceled)

213. The mobile device of claim 178, wherein adjusting the speaker output comprises adjusting a frequency profile of the speaker to a preferred frequency profile at the target location.

214-216. (canceled)

217. The mobile device of claim 178, wherein adjusting the speaker output comprises adjusting a frequency profile of the speaker to a non-preferred frequency profile at a location other than the target location.

218-228. (canceled)

229. The mobile device of claim 178, wherein the processing circuit is further configured to adjust a setting of the mobile device based on the calculated distance.

230-336. (canceled)
